(19) United States
(12) Patent Application Publication
(10) Pub. No.: US 2023/0196123 A1
(43) Pub. Date: Jun. 22, 2023

(54) Federated Learning in Machine Learning

(71) Applicant: Nozomu KUBOTA, Tokyo (JP)

(72) Inventor: Nozomu KUBOTA, Tokyo (JP)

(21) Appl. No.: 18/083,363

(22) Filed: Dec. 16, 2022

(30) Foreign Application Priority Data
Dec. 17, 2021 (JP) 2021-204794

(51) Int. Cl. G06N 3/0985; G06N 3/09

(52) U.S. Cl. CPC G06N 3/0985; G06N 3/09

(57) ABSTRACT

Provided is a new mechanism enabling an appropriate distributed instance number or a hyperparameter to be specified with respect to a prescribed data set. An information processing method performed by an information processing apparatus having a storage device storing a prescribed learning model, and a processor, the method includes the steps of: causing, by the processor, other respective information processing apparatuses to perform, on one or a plurality of data sets, machine learning by using the prescribed learning model according to respective combinations in which an instance number and a hyperparameter learned in parallel are arbitrarily changed; acquiring, by the processor, learning performance, corresponding to the respective combinations, from the respective information processing apparatuses; performing, by the processor, supervised learning by using learning data including the respective combinations and the learning performance corresponding to the respective combinations; and generating, by the processor, a prediction model that predicts learning performance for each combination of an instance number and a hyperparameter by the supervised learning.

### BACKGROUND

### Field

The present invention relates to an information processing method, an information processing apparatus, and a program for performing distributed learning in machine learning.

### Description of Related Art

In recent years, attempt has been made to apply so-called artificial intelligence to various problems. For example, Patent Publication JP-A-2019-220063 describes a model selection device used to solve problems in various realistic events.

Prior Art List, Patent Publication JP-A-2019-220063

### SUMMARY

Here, in performing machine learning, parallel processing can be, for example, performed with tasks distributed in order to reduce a processing time. In this manner, the load of the machine learning is distributed, which makes it possible to more quickly output a prediction result.

However, in federated learning (hereinafter also referred to “distributed learning”) in which machine learning is distributed to perform learning, there is need to tune a hyperparameter when performing dislearning. On this occasion, it has been revealed by the experiment of the inventor that a prediction result greatly changes only with the different tuning of the hyperparameter even where the distributed learning is performed. For example, accuracy or robustness changes only with the change of the setting of weight decay representing one hyperparameter.

Accordingly, the present invention provides a new mechanism enabling an appropriate distributed instance number or a hyperparameter to be specified with respect to a prescribed data set.

An aspect of the present invention provides an information processing method performed by an information processing apparatus having a storage device storing a prescribed learning model, and a processor, the method including the steps of: causing, by the processor, other respective information processing apparatuses to perform, on one or a plurality of data sets, machine learning by using the prescribed learning model according to respective combinations in which an instance number and a hyperparameter learned in parallel are arbitrarily changed; acquiring, by the processor, learning performance, corresponding to the respective combinations, from the respective information processing apparatuses; performing, by the processor, supervised learning by using learning data including the respective combinations and the learning performance corresponding to the respective combinations; and generating, by the processor, a prediction model that predicts learning performance for each combination of an instance number and a hyperparameter by the supervised learning.

According to the present invention, it is possible to provide a new mechanism enabling an appropriate distributed instance number or a hyperparameter to be specified with respect to a prescribed data set.

### BRIEF DESCRIPTION OF DRAWINGS

FIG. 1 is a diagram showing an example of a system configuration according to an embodiment;

FIG. 2 is a diagram showing an example of the physical configurations of an information processing apparatus according to the embodiment;

FIG. 3 is a diagram showing an example of the processing blocks of a server according to the embodiment;

FIG. 4 is a diagram showing an example of the processing blocks of an information processing apparatus according to the embodiment;

FIG. 5 is a diagram showing an example of relationship information according to the embodiment;

FIG. 6 is a diagram showing a display example of the relationship information according to the embodiment;

FIG. 7 is a sequence diagram showing a processing example of the server and the respective information processing apparatuses according to the embodiment; and

FIG. 8 is a flowchart showing a processing example relating to the use of the relationship information of the server according to the embodiment.

### DETAILED DESCRIPTION

An embodiment of the present invention will be described with reference to the accompanying drawings. Note that components with the same symbols have the same or similar configurations in the respective drawings.

System Configuration

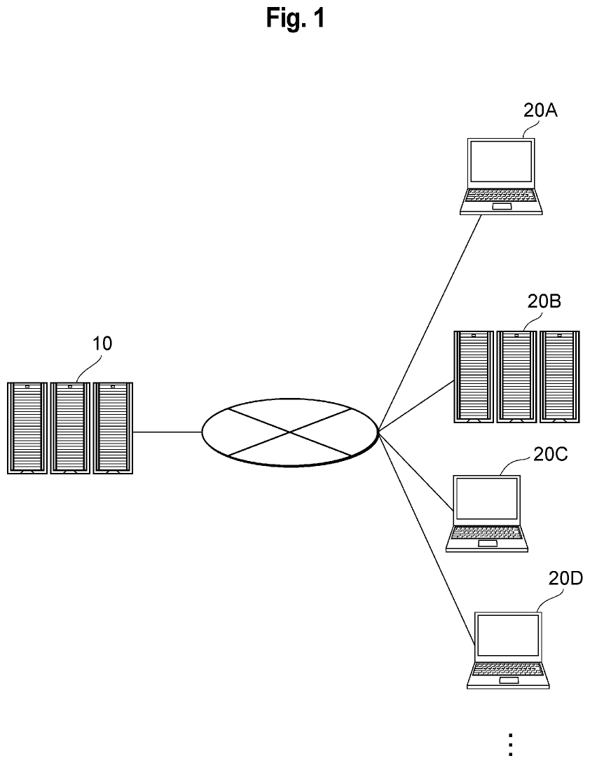

FIG. 1 is a diagram showing an example of a system configuration according to the embodiment. In the example shown in FIG. 1, a server 10 and respective information processing apparatuses 20A, 20B, 20C, and 20D are connected to be able to send and receive data to and from each other via a network. The information processing apparatuses are also represented as information processing apparatuses 20 when they are not separately distinguished from each other.

The server 10 is an information processing apparatus able to collect and analyze data and may be constituted by one or a plurality of information processing apparatuses. The information processing apparatuses 20 are information processing apparatuses such as smart phones, personal computers, tablet terminals, servers, and connected cars that are able to perform machine learning. Note that the information processing apparatuses 20 are directly or indirectly connected to invasive or non-invasive electrodes that sense brain waves and may also be apparatuses able to analyze and send and receive brain wave data to and from each other.

In the system shown in FIG. 1, the server 10 controls distributed learning with respect to prescribed machine learning. For example, in prescribed machine learning, the server 10 performs any of data parallelism in which mini-batches are distributed to a plurality of information processing apparatuses and model parallelism in which one model is distributed to a plurality of information processing apparatuses to perform distribution.

Here, in the case of the distributed learning, an engineer conventionally performs hyperparameter tuning or the determination of a distributed instance number and is unable to find out a result before conducting an experiment. If a desired result is not obtained when the engineer performs the distributed learning over time, an experiment is conducted again after a hyperparameter is tuned or a distributed instance number is changed, which makes the distributed learning inefficient.

In view of this, the server 10 performs distributed learning in advance with respect to an arbitrary data set and labels learning performance or learning times (the maximum values or the like of the respective learning times) acquired from the respective information processing apparatuses 20 with groups of distributed instance numbers and/or hyperparameters in learning. Next, the server 10 performs supervised learning using learning data including the groups of the distributed instance numbers and/or the hyperparameters and the learning performance and the learning times. As a result of the supervised learning, a prediction model that predicts learning performance or a learning time is generated for each group of a distributed instance number and a hyperparameter with respect to a prescribed data set.

Accordingly, an engineer has no need to conduct an experiment and tune a hyperparameter or a distributed instance number in distributed learning and is enabled to specify a distributed instance number and/or a hyperparameter corresponding to desired learning performance or a learning time with respect to a prescribed data set. Hereinafter, the configurations of the respective apparatuses of the present embodiment will be described.

Hardware Configurations

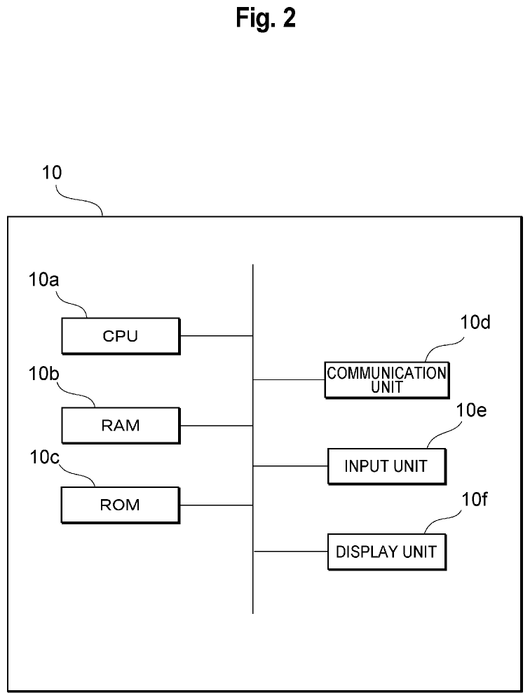

FIG. 2 is a diagram showing an example of the physical configurations of an information processing apparatus 10 according to the embodiment. The information processing apparatus 10 has a CPU (Central Processing Unit) 10a corresponding to a computation unit, a RAM (Random Access Memory) 10b corresponding to a storage unit, a ROM (Read only Memory) 10c corresponding to a storage unit, a communication unit 10d, an input unit 10e, and a display unit 10f. These respective configurations are connected to be able to send and receive data to and from each other via a bus.

The present embodiment will describe a case in which the information processing apparatus 10 is constituted by one computer. However, the information processing apparatus 10 may be realized by a combination of a plurality of computers or a plurality of computation units. Further, the configurations shown in FIG. 2 are given as an example. The information processing apparatus 10 may have configurations other than these configurations or may not have a part of these configurations.

The CPU 10a is an example of a processor and is a control unit that performs control relating to the running of a program stored in the RAM 10b or the ROM 10c or the computation and processing of data. The CPU 10a is, for example, a computation unit that runs a program (learning program) to perform learning using a prescribed learning model. The CPU 10a receives various data from the input unit 10e or the communication unit 10d and displays the computation result of the data on the display unit 10f or stores the same in the RAM 10b.

The RAM 10b is a data-rewritable storage unit and may be constituted by, for example, a semiconductor storage element. The RAM 10b may store a program run by the CPU 10a, respective learning models (such as a prediction model and a learning model for distributed learning), data relating to the parameters of respective learning models, data relating to the feature amount of learning target data, or the like. Note that these examples are given for illustration. The RAM 10b may store data other than these data or may not store a part of these data.

The ROM 10c is a data-readable storage unit and may be constituted by, for example, a semiconductor storage element. The ROM 10c may store, for example, a learning program or data that is not rewritten.

The communication unit 10d is an interface that is used to connect the information processing apparatus 10 to other equipment. The communication unit 10d may be connected to a communication network such as the Internet.

The input unit 10e is a unit that receives the input of data from a user and may include, for example, a keyboard and a touch panel.

The display unit 10f is a unit that visually displays a computation result by the CPU 10a and may be constituted by, for example, an LCD (Liquid Crystal Display). The display of a computation result on the display unit 10f can contribute to XAI (eXplainable AI). The display unit 10f may display, for example, a learning result or data relating to learning.

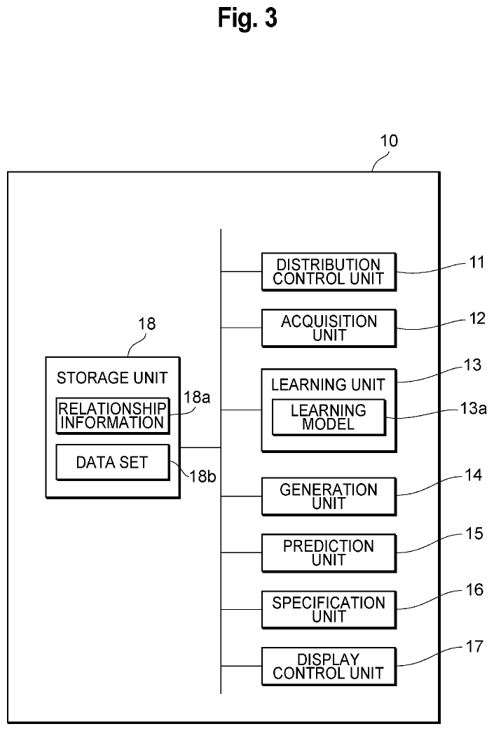

The learning program may be provided in a state of being stored in a non-transitory computer-readable storage medium such as the RAM 10b and the ROM 10c or may be provided via a communication network connected by the communication unit 10d. In the information processing apparatus 10, various operations that will be described later using FIG. 3 are realized when the CPU 10a runs the learning program. Note that these physical configurations are given for illustration and may not be necessarily independent configurations. For example, the information processing apparatus 10 may include an LSI (Large-Scale Integration) in which the CPU 10a and the RAM 10b or the ROM 10c are integrated. Further, the information processing apparatus 10 may include a GPU (Graphical Processing Unit) or an ASIC (Application Specific Integrated Circuit).

Note that the configurations of the information processing apparatuses 20 are the same as those of the information processing apparatus 10 shown in FIG. 2 and therefore their descriptions will be omitted. Further, the information processing apparatus 10 and the information processing apparatuses 20 may only have the CPU 10a, the RAM 10b, or the like that is a basic configuration to perform data processing and may not have the input unit 10e or the display unit 10f. Further, the input unit 10e or the display unit 10f may be connected from the outside by an interface.

Processing Configurations

FIG. 3 is a diagram showing an example of the processing blocks of the information processing apparatus (server) 10 according to the embodiment. The information processing apparatus 10 includes a distribution control unit 11, an acquisition unit 12, a learning unit 13, a generation unit 14, a prediction unit 15, a specification unit 16, a display control unit 17, and a storage unit 18. The information processing apparatus 10 may be constituted by a general-purpose computer.

The distribution control unit 11 causes the respective information processing apparatuses 20 to perform, with respect to one or a plurality of data sets, machine learning using a prescribed learning model according to respective combinations in which an instance number and/or a hyperparameter learned in parallel are/is arbitrarily changed. For example, the distribution control unit 11 sets a distributed instance number N at 2 and sets a hyperparameter H at a prescribed value. The hyperparameter H includes, for example, one or a plurality of parameters, and respective values are set to the respective parameters. The hyperparameter H may represent a group of a plurality of parameters.

The data set includes, for example, at least any of image data, series data, and text data. Here, the image data includes still-image data and moving-image data. The series data includes sound data, stock price data, or the like.

When setting a distributed instance number and a hyperparameter, the distribution control unit 11 outputs the set hyperparameter to the information processing apparatuses 20 corresponding to the distributed instance number N and causes the information processing apparatuses 20 to perform distributed learning. At this time, the distribution control unit 11 may output a learning model for the distributed learning to the information processing apparatuses 20. Further, the distribution control unit 11 may regard the own apparatus as being involved in the distributed learning.

The distribution control unit 11 instructs the respective information processing apparatuses 20 to perform distributed learning every time the distribution control unit 11 changes the distributed instance number N or the hyperparameter H. For example, the distribution control unit 11 changes the hyperparameter H with the distributed instance number N fixed, and increments the distributed instance number by one when entirely completing the change of the hyperparameter H. This processing is repeatedly performed until the distributed instance number reaches an upper limit. In this manner, the distribution control unit 11 is enabled to cause the respective information processing apparatuses 20 to perform distributed learning according to various combinations of distributed instance numbers and hyperparameters.

The acquisition unit 12 acquires learning performance corresponding to each combination of a distributed instance number and a hyperparameter from the respective information processing apparatuses 20. For example, the acquisition unit 12 acquires respective learning results from the respective information processing apparatuses 20 that have performed distributed learning. The learning results include at least learning performance.

For example, the learning performance of a learning model may be represented as an F value, the F value/(the calculation time of learning processing), or the value of a loss function. Note that the F value is a value calculated by 2PR/(P+R) where a precision ratio (precision) is represented as P and a recall ratio (recall) is represented as R. Further, the learning performance may be represented using, for example, ME (Mean Error), MAE (Mean Absolute Error), RMSE (Root Mean Squared Error), MPE (Mean Percentage Error), MAPE (Mean Absolute Percentage Error), RMSPE (Root Mean Squared Percentage Error), ROC (Receiver Operating Characteristic) curve, AUC (Area Under the Curve), Gini Norm, Kolmogorov-Smirnov, Precision/Recall, or the like.

Further, the acquisition unit 12 may calculate, as learning performance with respect to a certain combination of a distributed instance number and a hyperparameter, one learning performance, for example, a mean value, a central value, a maximum value, or a minimum value using a plurality of learning performance acquired from the respective information processing apparatuses 20.

The learning unit 13 performs supervised learning using learning data including respective combinations of distributed instance numbers and hyperparameters with respect to an arbitrary data set and learning performance corresponding to the respective combinations. In this supervised learning, a prescribed learning model 13a is used. For example, the learning model 13a is a model that predicts, using an arbitrary data set as input, learning performance for each combination of a distributed instance number and a hyperparameter.

The prescribed learning model 13a is, for example, a prediction model and includes at least one of an image recognition model, a series-data analysis model, a robot control model, a reinforcement learning model, a sound recognition model, a sound generation model, an image generation model, a natural language processing model, and the like. Further, a specific example of the prescribed learning model 13a is CNN (Convolutional Neural Network), RNN (Recurrent Neural Network), DNN (Deep Neural Network), LSTM (Long Short-Term Memory), bi-directional LSTM, DQN (Deep Q-Network), VAE (Variational AutoEncoder), GANs (Generative Adversarial Networks), a flow-based generation model, or the like.

Further, the learning model 13a includes a model obtained by performing the pruning, quantization, distillation, or transfer of a learned model. Note that these models are only given as an example and the learning unit 13 may perform the machine learning of a learning model with respect to other problems. The learning unit 13 may select the learning model 13a according to the feature of a data set to be learned and perform supervised learning using the learning model. Further, a loss function used in the learning unit 13 may be a squared error function relating to the output and label data of the learning model 13a or may be a cross-entropy loss function. In order to reduce the value of a loss function, the learning unit 13 repeatedly performs learning while tuning a hyperparameter using back propagation until a prescribed condition is satisfied.

The generation unit 14 generates a prediction model according to supervised learning by the learning unit 13. The prediction model includes a model generated as a result of learning with the learning model 13a. For example, the prediction model is a model that predicts, using an arbitrary data set as input, learning performance for each combination of a distributed instance number and a hyperparameter.

By the above processing, new mechanism enabling the specification of an appropriate distributed instance number or a hyperparameter with respect to a prescribed data set may be provided. For example, by performing distributed learning in advance using an arbitrary distributed instance number or a hyperparameter with respect to various data sets, it is possible to generate a multiplicity of teacher data. Further, by acquiring the results of distributed learning and performing supervised learning using the results as teacher data, the server 10 is enabled to predict learning performance for each combination of a distributed instance number and a hyperparameter with respect to an arbitrary data set.

The prediction unit 15 predicts learning performance obtained when a prescribed data set is input to a prediction model and the machine learning of a prescribed learning model is performed for each combination of a distributed instance number and a hyperparameter. For example, the prediction unit 15 may predict learning performance for each combination and rearrange the combinations in descending order of the learning performance.

By the above processing, the server 10 is enabled to predict learning performance for each combination of a distributed instance number and a hyperparameter with respect to a new data set. Accordingly, an engineer has no need to tune a distributed instance number or a hyperparameter and is enabled to efficiently use the computer resources of the server 10 or the respective information processing apparatuses 20.

Further, the acquisition unit 12 may also acquire learning times together with learning performance as learning results from the respective information processing apparatuses 20 that have been instructed to perform distributed learning. As for the learning times, the information processing apparatuses 20 measure a time before a result is obtained since the start of learning. Any of a mean value, a maximum value, a central value, and a minimum value of respective learning times acquired from the respective information processing apparatuses 20 may be used as the learning time.

The learning unit 13 may also perform supervised learning using learning data including each combination of a distributed instance number and a hyperparameter and a combination of learning performance and a learning time corresponding to the combination. For example, the learning unit 13 performs, with the input of a prescribed data set to the learning model 13a, supervised learning to predict learning performance and a learning time for each combination of a distributed instance number and a hyperparameter.

The generation unit 14 may generate a prediction model that predicts learning performance and a learning time for each combination of a distributed instance number and a hyperparameter when supervised learning is performed using learning data including a learning time.

By the above processing, it is possible to predict not only learning performance but also a learning time in a case in which distributed learning is performed. A distributed instance number or a hyperparameter becomes selectable in consideration of learning performance and a learning time. For example, a combination of a distributed instance number and a hyperparameter corresponding to an allowable learning time or learning performance becomes selectable even if a learning time or learning performance is not optimum.

The prediction unit 15 may predict learning performance and a learning time obtained when the machine learning of a prescribed learning model is performed with the input of a prescribed data set to a prediction model for each combination of a distributed instance number and a hyperparameter.

By the above processing, the server 10 is enabled to predict learning performance and a learning time for each combination of a distributed instance number and a hyperparameter with respect to a new data set. Accordingly, an engineer has no need to tune a distributed instance number or a hyperparameter and is enabled to efficiently use the computer resources of the server 10 or the respective information processing apparatuses 20.

Further, the generation unit 14 assumes learning performance and a learning time as a first variable and a second variable, respectively, using results predicted by the prediction unit 15 and generates relationship information (prediction relationship information) in which the first and second variables and an instance number and/or a hyperparameter are associated with each other. For example, assuming that a vertical axis is a first variable and a horizontal axis is a second variable, the generation unit 14 may generate a matrix in which a distributed instance number or a hyperparameter is associated with the intersection of each variable. Further, on the basis of learning performance or learning times acquired from the respective information processing apparatuses 20, the generation unit 14 may generate relationship information (actual measurement relationship information) in which first and second variables and an instance number and/or a hyperparameter are associated with each other.

By the above processing, it is possible to promptly specify a corresponding distributed instance number or a hyperparameter when a first variable or a second variable is changed. Further, the first variable and the second variable may be appropriately changed. For example, when learning performance and a distributed instance number are applied as a first variable and a second variable, respectively, specified information may be a combination of a hyperparameter and a learning time.

Further, the acquisition unit 12 may acquire a first value of a first variable and a second value of a second variable. For example, the acquisition unit 12 acquires a first value of a first variable and a second value of a second variable designated by a user. The first value or the second value is appropriately designated by the user.

In this case, the specification unit 16 specifies an instance number and/or a hyperparameter corresponding to the first value of the first variable and the second value of the second variable on the basis of relationship information generated by the generation unit 14. For example, the specification unit 16 specifies an instance number and/or a hyperparameter corresponding to a changed value of a first variable or a changed value of a second variable using relationship information.

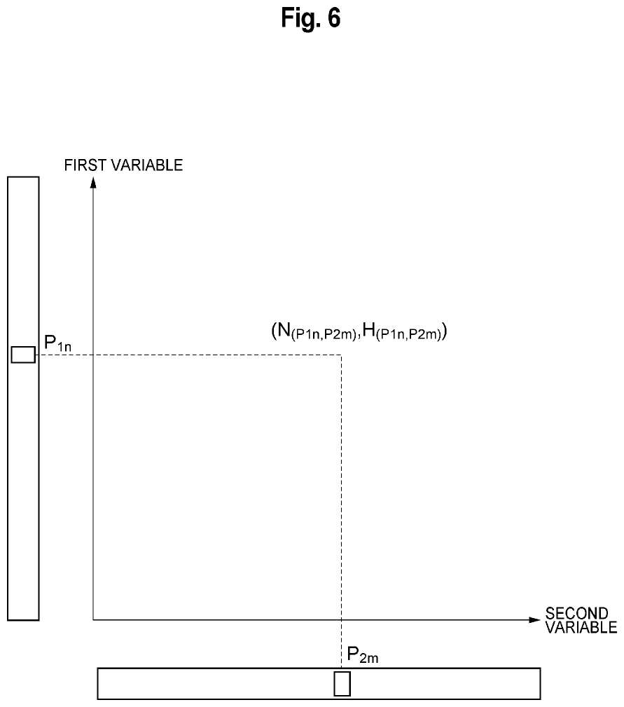

The display control unit 17 performs control to display an instance number and/or a hyperparameter specified by the specification unit 16 on the display device (display unit 10f). Further, the display control unit 17 may show a matrix enabling the change of a first variable and a second variable through a GUI (Graphical User Interface) (for example, FIG. 6 or the like that will be described later).

By the above processing, it is possible to visualize, for a user, a distributed instance number or a hyperparameter specified according to a first variable or a second variable designated by the user. By changing a first variable or a second variable, the user is enabled to specify a desired distributed instance number or a hyperparameter and apply the specified distributed instance number or the hyperparameter to distributed learning.

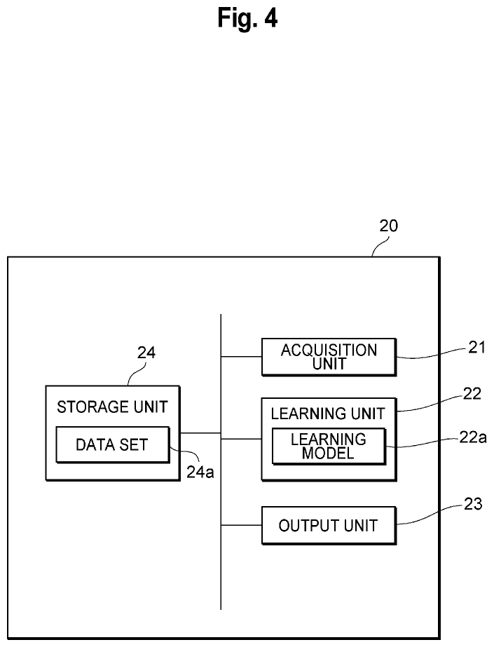

FIG. 4 is a diagram showing an example of the processing blocks of the information processing apparatuses 20 according to the embodiment. The information processing apparatuses 20 include an acquisition unit 21, a learning unit 22, an output unit 23, and a storage unit 24. The information processing apparatuses 20 may be constituted by general-purpose computers.

The acquisition unit 21 may acquire information relating to a prescribed learning model or information relating to a prescribed data set together with instructions to perform distributed learning from another information processing apparatus (for example, the server 10). The information relating to the prescribed learning model may only be a hyperparameter or the prescribed learning model itself. The information relating to the prescribed data set may be the data set itself or may be information showing a storage destination in which the prescribed data set is stored.

The learning unit 22 performs learning with the input of a prescribed data set serving as a learning target to a learning model 22a that performs prescribed learning. The learning unit 22 performs control to provide feedback about a learning result after learning to the server 10. The learning result may include, for example, a hyperparameter after tuning, learning performance, or the like and also include a learning time. The learning unit 22 may select the learning model 22a depending on the type of a data set serving as a learning target and/or a problem to be solved.

Further, the prescribed learning model 22a is a learning model including a neural network and includes, for example, at least one of an image recognition model, a series-data analysis model, a robot control model, a reinforcement learning model, a sound recognition model, a sound generation model, an image generation model, a natural language processing model, and the like. Further, a specific example of the prescribed learning model 22a is CNN (Convolutional Neural Network), RNN (Recurrent Neural Network), DNN (Deep Neural Network), LSTM (Long Short-Term Memory), bi-directional LSTM, DQN (Deep Q-Network), VAE (Variational AutoEncoder), GANs (Generative Adversarial Networks), a flow-based generation model, or the like.

Further, the learning model 22a includes a model obtained by performing the pruning, quantization, distillation, or transfer of a learned model. Note that these models are only given as an example and the learning unit 22 may perform the machine learning of a learning model with respect to other problems. Further, a loss function used in the learning unit 22 may be a squared error function relating to the output and label data of the learning model 22a or may be a cross-entropy loss function. In order to reduce the value of a loss function, the learning unit 22 repeatedly performs learning while tuning a hyperparameter using back propagation until a prescribed condition is satisfied.

The output unit 23 outputs information relating to the learning result of distributed learning to another information processing apparatus. For example, the output unit 23 outputs information relating to a learning result by the learning unit 22 to the server 10. For example, the information relating to the learning result of the distributed learning includes learning performance and a hyperparameter after tuning and may also include a learning time as described above.

The storage unit 24 stores data relating to the learning unit 22. The storage unit 24 stores a prescribed data set 24a, data acquired from the server 10, data that is being learned, information relating to a learning result, or the like.

In this manner, the information processing apparatuses 20 are enabled to perform distributed learning with respect to a prescribed data set according to instructions from another information processing apparatus (for example, the server 10) and provide feedback about a learning result to the server 10.

Further, the respective information processing apparatuses 20 are enabled to perform, with respect to a new data set, distributed learning using a hyperparameter or a distributed instance number predicted by the server 10. Accordingly, an engineer or the like has no need to tune a hyperparameter or a distributed instance number in the respective information processing apparatuses 20 and is enabled to efficiently use the hardware resources or software resources of the respective information processing apparatuses 20.

Data Example

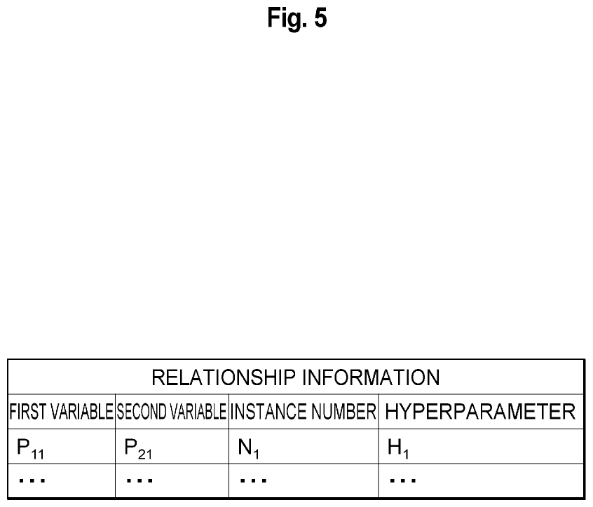

FIG. 5 is a diagram showing an example of relationship information according to the embodiment. In the example shown in FIG. 5, the relationship information is actual measurement relationship information in which information obtained by performing distributed learning is consolidated and includes distributed instance numbers (for example, N₁) and hyperparameters (for example, H₁) corresponding to respective first variables (for example, P₁₁) and respective second variables (for example, P₂₁). A first variable P₁ₙ is, for example, learning performance, and a second variable P₂ₙ is, for example, a learning time. Only any of the first variable P₁ₙ and the second variable Pen may be used. A hyperparameter H may be a group of parameters used in machine learning. For example, a hyperparameter H is weight decay, a unit number in an intermediate layer, or the like, and may include a parameter peculiar to a learning model.

As for the relationship information shown in FIG. 5, the server 10 acquires learning performance (first variable) and a learning time (second variable) from any information processing apparatus 20 caused to perform distributed learning according to a combination of a prescribed distributed instance number and a hyperparameter. The server 10 associates the prescribed distributed instance number and the hyperparameter with the acquired learning performance and the learning time. By performing the associating operation every time the server 10 acquires learning performance and a learning time from each of the information processing apparatuses 20, it is possible to generate the relationship information shown in FIG. 5. Further, predicted relationship information with respect to an arbitrary data set may be generated as the relationship information on the basis of a result predicted by the prediction unit 15.

Example of User Interface

FIG. 6 is a diagram showing a display example of relationship information according to the embodiment. In the example shown in FIG. 6, a first variable and a second variable included in predicted relationship information are made changeable with slide bars. When a user moves the first variable and the second variable with the slide bars, a combination (N_{(P1n, P2m)}, H_{(p1n, P2m)}) of learning performance and a hyperparameter corresponding to a first variable (P₁ₙ) or a second variable (P₂ₘ) after the movement is displayed in association with a corresponding point.

Further, when the user designates a prescribed point on the two-dimensional graph of a first variable and a second variable, a combination of learning performance N and a hyperparameter H corresponding to the designated point may be displayed. Note that when a hyperparameter H includes a plurality of parameters, the plurality of parameters may be displayed with the selection of the hyperparameter H.

In this manner, the server 10 is enabled to display a combination of learning performance and a learning time corresponding to a combination of a first variable and a second variable. Further, it is possible to provide a user interface that causes, while visually showing a corresponding relationship for the user, the user to select an appropriate distributed instance number or a hyperparameter with respect to an arbitrary data set that is to be subjected to distributed learning.

Processing Example

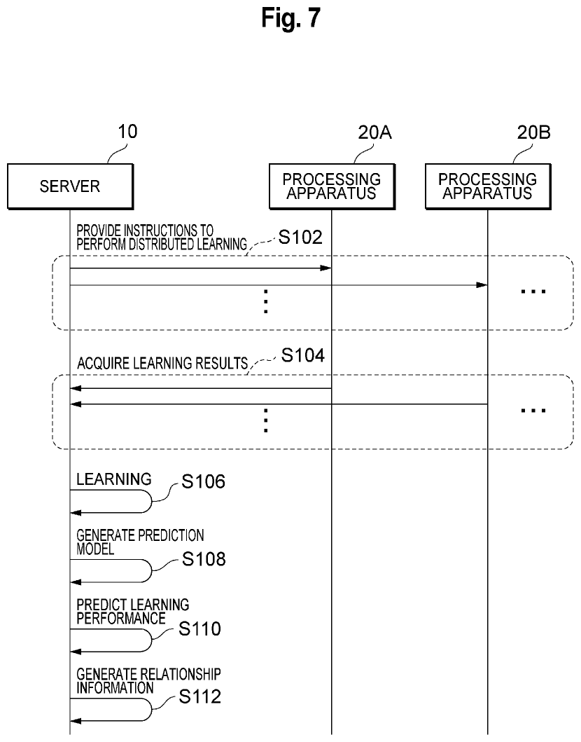

FIG. 7 is a sequence diagram showing a processing example of the server 10 and the respective information processing apparatuses 20 according to the embodiment. In the example shown in FIG. 7, the information processing apparatuses are represented as “processing apparatuses” and indicate apparatuses that perform distributed learning.

In step S102, the distribution control unit 11 of the server 10 performs control to cause the processing apparatuses 20 having a prescribed distributed instance number to perform learning with the application of a prescribed hyperparameter. For example, the distribution control unit 11 selects the processing apparatuses 20 having a prescribed distributed instance number and instructs the selected processing apparatuses 20 having the distributed instance number to perform learning with a set prescribed hyperparameter.

In step S104, the respective processing apparatuses 20 that have performed the distributed learning send information relating to learning results to the server 10. The information relating to the learning results includes, for example, learning performance and/or learning times. The acquisition unit 12 of the server 10 acquires the information relating to the learning results from the respective processing apparatuses 20.

In step S106, the learning unit 13 of the server 10 performs supervised learning using the learning model (prediction model) 13a that predicts learning performance or a learning time and learning data in which learning performance and learning times acquired from the respective processing apparatuses 20 are assumed as correct answer labels with respect to the respective combinations of distributed instance numbers and hyperparameters in a prescribed data set.

In step S108, the generation unit 14 of the server 10 generates a model generated by the learning of the learning unit 13 as a prediction model. For example, the prediction model is a model that predicts learning performance or a learning time for each combination of a distributed instance number and a hyperparameter using an arbitrary data set as input.

In step S110, the prediction unit 15 of the server 10 inputs a new arbitrary data set to the prediction model and predicts learning performance and/or a learning time for each combination of a distributed instance number and a hyperparameter.

In step S112, the generation unit 14 of the server 10 assumes the learning performance and the learning times as first variables and second variables, respectively, on the basis of the prediction results of the prediction unit 15 and generates relationship information in which the first and second variables and the instance numbers and/or the hyperparameters are associated with each other.

By the above processing, the server 10 is enabled to generate a prediction model that predicts learning performance and/or a learning time for each combination of a distributed instance number and a hyperparameter with respect to a prescribed data set using learning results by the respective processing apparatuses 20 that have been caused to perform distributed learning. Thus, there is no need to tune a distributed instance number or a hyperparameter for each data set, and the processing apparatuses are enabled to efficiently perform distributed learning.

Further, the server 10 is also enabled to construct relationship information corresponding to a learning model by causing the processing apparatuses to perform distributed learning while appropriately changing a combination of a distributed instance number and a hyperparameter for each learning model subjected to the distributed learning and acquiring learning results. Thus, the server 10 is enabled to specify an appropriate distributed instance number or a hyperparameter with respect to a prescribed data set using a prediction model corresponding to a prescribed learning model.

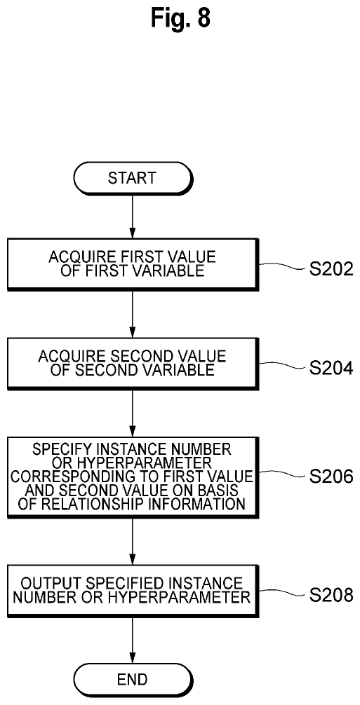

Next, an example of using relationship information will be described. FIG. 8 is a flowchart showing a processing example relating to the use of the relationship information of the server 10 according to the embodiment. In the example shown in FIG. 8, relationship information is displayed on a screen in a graph form as shown in FIG. 6 to display a distributed instance number or a hyperparameter according to a user operation.

In step S202, the acquisition unit 12 of the server 10 receives a user operation via the input unit 10e and acquires a first value of a first variable. The first value is a value changed according to a user operation (for example, the movement of a slide bar).

In step S204, the acquisition unit 12 of the server 10 receives a user operation via the input unit 10e and acquires a second value of a second variable. The second value is a value changed according to a user operation (for example, the movement of a slide bar).

In step S206, the specification unit 16 specifies an instance number and/or a hyperparameter corresponding to the first value of the first variable and the second value of the second variable on the basis of relationship information (for example, predicted relationship information) generated by the generation unit 14. For example, the specification unit 16 specifies an instance number and/or a hyperparameter corresponding to the changed value of the first variable or the changed value of the second variable using the relationship information.

In step S208, the display control unit 17 outputs the instance number and/or the hyperparameter specified by the specification unit 16 to the display device (display unit 10f). Further, the display control unit 17 may show a matrix enabling the change of the first variable and the second variable through a GUI.

By the above processing, the user is enabled to grasp learning performance or a learning time for each combination of a distributed instance number and a hyperparameter when performing distributed learning using a prescribed data set and a prescribed learning model. Further, the user is enabled to specify a distributed instance number or a hyperparameter corresponding to a changed parameter by changing the parameter of learning performance or a learning time.

The embodiment described above intends to facilitate the understanding of the present invention and does not intend to interpret the present invention in a limited way. The respective elements provided in the embodiment and their arrangements, materials, conditions, shapes, sizes, or the like are not limited to the illustrated ones but may be appropriately changed. Further, configurations shown in different embodiments may be partially replaced or combined with each other.

In the above embodiment, the learning unit 22 of the information processing apparatus 10 may be mounted in another apparatus. In this case, the information processing apparatus 10 may instruct the other apparatus to perform learning processing to generate a prediction model.

What is claimed is:

1. An information processing method performed by an information processing apparatus having a storage device storing a prescribed learning model, and a processor, the method comprising the steps of:
causing, by the processor, other respective information processing apparatuses to perform, on one or a plurality of data sets, machine learning by using the prescribed learning model according to respective combinations in which an instance number and a hyperparameter learned in parallel are arbitrarily changed;
acquiring, by the processor, learning performance, corresponding to the respective combinations, from the respective information processing apparatuses;
performing, by the processor, supervised learning by using learning data including the respective combinations and the learning performance corresponding to the respective combinations; and
generating, by the processor, a prediction model that predicts learning performance for each combination of an instance number and a hyperparameter by the supervised learning.

2. The information processing method according to claim 1, wherein
the processor predicts, for each of the combinations, learning performance obtained when the prescribed data set is input to the prediction model and machine learning of the prescribed learning model is performed.

3. The information processing method according to claim 1, wherein
the acquisition of the learning performance includes acquiring a learning time together with the learning performance,
the performing of the supervised learning includes performing supervised learning by using learning data including the respective combinations and learning performance and learning times corresponding to the respective combinations, and
the generation of the prediction model includes generating a prediction model that predicts learning performance and a learning time for each combination of an instance number and a hyperparameter by the supervised learning.

4. The information processing method according to claim 3, wherein
the processor predicts, for each of the combinations, learning performance and a learning time obtained when a prescribed data set is input to the prediction model and machine learning of the prescribed learning model is performed.

5. The information processing method according to claim 3, wherein
the processor, with the learning performance being a first variable and with the learning time being a second variable, generates relationship information in which the first and second variables and the instance number and hyperparameter are associated with each other.

6. The information processing method according to claim 5, wherein
the processor
acquires a first value of the first variable and a second value of the second variable, and
specifies an instance number and a hyperparameter corresponding to the first value and the second value on a basis of the relationship information.

7. The information processing method according to claim 6, wherein
the processor performs control to display the specified instance number and the hyperparameter on a display device.

8. An information processing apparatus comprising:
a storage device; and
a processor, wherein
the storage device stores a prescribed learning model, and
the processor
causes other respective information processing apparatuses to perform, on one or a plurality of data sets, machine learning by using the prescribed learning model according to respective combinations in which an instance number and a hyperparameter learned in parallel are arbitrarily changed,
acquires learning performance, corresponding to the respective combinations, from the respective information processing apparatuses,
performs supervised learning by using learning data including the respective combinations and the learning performance corresponding to the respective combinations, and
generates a prediction model that predicts learning performance for each combination of an instance number and a hyperparameter by the supervised learning.

9. A non-transitory computer-readable recording medium having a program recorded thereon, wherein the program causes
a processor of an information processing apparatus having a storage device that stores a prescribed learning model, and the processor to
cause other respective information processing apparatuses to perform, on one or a plurality of data sets, machine learning by using the prescribed learning model according to respective combinations in which an instance number and a hyperparameter learned in parallel are arbitrarily changed,
acquire learning performance, corresponding to the respective combinations, from the respective information processing apparatuses,
perform supervised learning by using learning data including the respective combinations and the learning performance corresponding to the respective combinations, and
generate a prediction model that predicts learning performance for each combination of an instance number and a hyperparameter by the supervised learning.
